(19) United States
(12) Patent Application Publication
(10) Pub. No.: US 2014/0073712 A1
(43) Pub. Date: Mar. 13, 2014

(54) POLYURETHANES COMPRISING HALOGEN COMPOUNDS

(71) Applicant: BASF SE, Ludwigshafen (DE)

(72) Inventors: Iran OTERO MARTINEZ, Stemwede (DE); Udo HADICK, Muenster (DE); Christian HAGEN, Lemfoerde (DE)

(73) Assignee: BASF SE, Ludwigshafen (DE)

(21) Appl. No.: 14/021,351

(22) Filed: Sep. 9, 2013

Related U.S. Application Data
(60) Provisional application No. 61/700,426, filed on Sep. 13, 2012.

(51) Int. Cl. C08L 75/08

(52) U.S. Cl. CPC C08L 75/08
USPC 521/137; 525/528; 525/65; 521/171; 521/174

(57) ABSTRACT

The present invention relates to polyurethanes obtainable via mixing of (a) polyisocyanate, (b) polymeric compounds having groups reactive toward isocyanates, (c) catalyst, (d) aliphatic hydrocarbon having from 2 to 15 carbon atoms and comprising at least one heteroatom selected from the group consisting of oxygen, nitrogen, and sulfur, and comprising at least one bromine and/or chlorine atom, (e) optionally blowing agent, (f) optionally chain extender and or crosslinking agent, and (g) optionally auxiliary and/or additives to give a reaction mixture and allowing the reaction mixture to complete its reaction to give the polyurethane, where the aliphatic hydrocarbon (d) comprises no phosphoric ester, polyphosphate, phosphonic ester, or phosphorous ester. The present invention further relates to a process for producing such polyurethanes, and to their use in the interior of conveyances.

The present invention relates to polyurethanes obtainable via mixing of (a) polyisocyanate, (b) polymeric compounds having groups reactive toward isocyanates, (c) catalyst, (d) aliphatic hydrocarbon having from 2 to 15 carbon atoms and comprising at least one heteroatom selected from the group consisting of oxygen, nitrogen, and sulfur, and comprising at least one bromine and/or chlorine atom, (e) optionally blowing agent, (f) optionally chain extender and or crosslinking agent, and (g) optionally auxiliary and/or additives to give a reaction mixture and allowing the reaction mixture to complete its reaction to give the polyurethane, where the aliphatic hydrocarbon (d) comprises no phosphoric ester, polyphosphate, phosphonic ester, or phosphorous ester. The present invention further relates to a process for producing such polyurethanes, and to their use in the interior of conveyances.

A feature of polyurethanes is that they are versatile. These materials are frequently used in particular in automobile construction, for example in the external shell of automobiles as spoilers, roof elements, or spring elements, and also in the internal cladding of automobiles as roof cladding, door cladding, cable insulation, steering wheels, control buttons, seat cushioning, or foam backings used for carpets, or those used for other components, such as instrument panels. Polyurethanes used in the automobile sector, in particular in automobile interiors, are subject to stringent requirements. There is therefore a demand for excellent mechanical properties which do not change over the lifetime of the automobile, the aim being that in each application sector the polyurethanes not only retain their function in everyday use, for example by providing cushioning properties, sound-deadening properties, haptic properties, or stabilization properties, but also provide their functions relevant to safety in the event of an accident, an example being the attenuation of a mechanical impact.

Relevant temperature and humidity conditions prevailing in automobiles are extreme, and accelerate the aging of the polyurethane: temperatures in the region of minus 10° C. and below, and also above 60° C., or even above 100° C. during insolation, can be reached. Relevant relative humidity levels can be up to 100%.

Another requirement in these extreme conditions of temperature and humidity is that polyurethanes used in automobile interiors cause minimal emissions of volatile compounds. These derive mostly from the use of volatile amine catalysts. With the aim of reducing emissions, said volatile amine catalysts are replaced entirely or to some extent by incorporable catalysts. These compounds catalyze the polyurethane reaction, but at the same time also have groups reactive toward isocyanate groups, and the catalysts therefore become securely incorporated into the polyurethane. However, said incorporable catalysts mostly impair the mechanical properties of the resultant polyurethane, in particular after heat-aging or heat-aging at high moisture level, i.e. under the types of conditions frequently encountered in automobile interiors. This is true in particular for polyurethane foams, where these have considerably greater surface area than compact polyurethane.

The use of chlorinated compounds in the production of polyurethanes is known: by way of example, WO 2009/065826 describes the use of chlorinated paraffins in the production of integral polyurethane foams. The chlorinated paraffins here serve for avoidance of core charring in large-volume parts, for example high-heeled ladies' shoes based on polyesterols and monoethylene glycol as chain extender. The use of halogenated short-chain hydrocarbons as blowing agents in the production of polyurethane foams is also known, examples being fluorochlorocarbons (FCCs). The use of fluorochlorocarbons is now banned, because they have properties detrimental to the ozone layer. Chlorinated paraffins are also suspected of being carcinogenic, and are therefore in essence no longer used or in some cases have already been banned.

The use of phosphorus-based flame retardants in polyurethanes is also known. Said organo-phosphorus flame retardants are mostly based on phosphate esters, phosphonate esters, or phosphite esters. The organic moieties of said esters mostly involve aliphatic or aromatic hydrocarbons, which can also be halogenated compounds. The binding of these compounds to the polyurethane matrix is mostly poor, and these materials therefore increase emissions and therefore cause undesirable odor. There are no descriptions of improvements in aging properties based on said flame retardants.

U.S. Pat. No. 3,756,970 also discloses the use of halogen sources such as ammonium chloride, ammonium bromide, tetramethylammonium chloride, tribromophenol, 2-bromopropane, 2-bromopropanol, 1,2-dibromopropane, 2,3-dibromopropene, 2,3-dibromopropanol, 2-chloropropane, 2-chloropropanol, 1,2-dichloropropane, 2,3-dichloropropene, and 2,3-dichloropropanol in conjunction with mineral acids and crude, undistilled phosgenation product of toluenediamine. Negative influences of the crude toluene diisocyanate are compensated by the use of combination of halogen source and mineral acid here.

It was an object of the present invention to improve the aging properties of polyurethanes, in particular at high temperatures and/or at high temperatures with high moisture content.

The object was achieved via polyurethanes obtainable via mixing of (a) polyisocyanate, (b) polymeric compounds having groups reactive toward isocyanates, (c) catalyst, (d) aliphatic hydrocarbon having from 2 to 15 carbon atoms and comprising at least one heteroatom selected from the group consisting of oxygen, nitrogen, and sulfur, and comprising at least one bromine and/or chlorine atom, (e) optionally blowing agent, (f) optionally chain extender and or crosslinking agent, and (g) optionally auxiliary and/or additives to give a reaction mixture and allowing the reaction mixture to complete its reaction to give the polyurethane, where the aliphatic hydrocarbon (d) comprises no phosphoric ester, polyphosphate, phosphonic ester, or phosphorous ester.

For the purposes of the invention, the term polyurethane covers all of the known polyisocyanate polyaddition products. These comprise adducts derived from isocyanate and alcohol, and they also comprise modified polyurethanes which can comprise isocyanurate structures, allophanate structures, urea structures, carbodiimide structures, uretonimine structures, or biuret structures, and they can comprise other isocyanate adducts. These polyurethanes of the invention comprise in particular compact polyisocyanate polyadducts, such as thermosets and foams based on polyisocyanate polyadducts, e.g. flexible foams, semirigid foams, rigid foams, or integral foams, and also polyurethane coatings and binders. For the purposes of the invention, the term polyurethanes also covers polymer blends comprising polyurethanes and other polymers, and also foams made of said polymer blends. It is preferable that the polyurethanes of the invention are polyurethane foams or compact polyurethanes which do not comprise any other polymers alongside the polyurethane unit components (a) to (g) explained hereinafter.

For the purposes of the invention, the term polyurethane foams covers foams in accordance with DIN 7726. Relevant flexible polyurethane foams of the invention exhibit a compressive stress at 10% compression or compressive strength in accordance with DIN 53 421/DIN EN ISO 604 of 15 kPa or less, preferably from 1 to 14 kPa, and in particular from 4 to 14 kPa. Semirigid polyurethane foams of the invention exhibit a compressive stress at 10% compression in accordance with DIN 53 421/DIN EN ISO 604 of from more than 15 to less than 80 kPa. Semirigid polyurethane foams and flexible polyurethane foams of the invention have an open-cell factor that is preferably greater than 85% in accordance with DIN ISO 4590, particularly preferably greater than 90%. Further details concerning flexible polyurethane foams and semirigid polyurethane foams of the invention are found in “Kunststoffhandbuch, Band 7, Polyurethane” [Plastics handbook, volume 7, Polyurethanes], Carl Hanser Verlag, 3rd edition, 1993, chapter 5.

The rigid polyurethane foams of the invention have a compressive stress at 10% compression that is greater than or equal to 80 kPa, preferably greater than or equal to 120 kPa, particularly preferably greater than or equal to 150 kPa. The rigid polyurethane foam moreover has a closed-cell factor of more than 80% in accordance with DIN ISO 4590, preferably more than 90%. Further details concerning rigid polyurethane foams of the invention are found in “Kunststoffhandbuch, Band 7, Polyurethane” [Plastics handbook, volume 7, Polyurethanes], Carl Hanser Verlag, 3rd edition, 1993, chapter 6.

For the purposes of this invention, the term elastomeric polyurethane foams covers polyurethane foams in accordance with DIN 7726 which after brief deformation by 50% of the thickness in accordance with DIN 53 577 after 10 minutes exhibit no residual deformation in excess of 2% of their initial thickness. The material involved here can be a rigid polyurethane foam, a semirigid polyurethane foam, or a flexible polyurethane foam.

Integral polyurethane foams involve polyurethane foams in accordance with DIN 7726 with a marginal zone which by virtue of the shaping process have a higher density than the core. The overall envelope density here is preferably more than 100 g/L, averaged over the core and the marginal zone. For the purposes of the invention, integral polyurethane foams can also involve rigid polyurethane foams, semirigid polyurethane foams, or flexible polyurethane foams. Further details concerning integral polyurethane foams of the invention are found in “Kunststoffhandbuch, Band 7, Polyurethane” [Plastics handbook, volume 7, Polyurethanes], Carl Hanser Verlag, 3rd edition, 1993, chapter 7.

Polyurethanes of the invention are obtained here by mixing polyisocyanates (a) with polymeric compounds (b) having groups reactive toward isocyanates, optionally catalysts (c), aliphatic hydrocarbon (d) having from 2 to 15 carbon atoms which comprises at least one heteroatom selected from the group consisting of oxygen, nitrogen, and sulfur, and which comprises at least one bromine and/or chlorine atom, and optionally blowing agent (e), chain extender (f), and other auxiliaries and additives (g) to give a reaction mixture and allowing the materials to complete their reaction.

In one preferred embodiment here, the polyurethane of the invention is a polyurethane foam with average density from 20 to 850 g/L, preferably a semirigid polyurethane foam or a flexible polyurethane foam or a rigid polyurethane foam, particularly preferably an elastomeric flexible polyurethane foam, a semirigid polyurethane foam, or an elastomeric integral polyurethane foam. The elastomeric integral polyurethane foam preferably has a density of from 150 to 500 g/L, averaged over the core and the marginal zone. The flexible polyurethane foam preferably has an average density of from 10 to 100 g/L. The semirigid polyurethane foam preferably has an average density of from 70 to 150 g/L.

In another preferred embodiment, the polyurethane is a compact polyurethane with a density that is preferably above 850 g/L, preferably from 900 to 1400 g/L, and particularly preferably from 1000 to 1300 g/L. A compact polyurethane here is in essence obtained without addition of a blowing agent. Small amounts of blowing agent, for example water, comprised in the polyols by virtue of the production process, are not considered here to be blowing agent. It is preferable that the reaction mixture for producing the compact polyurethane comprises less than 0.2% by weight of water, particularly preferably less than 0.1% by weight, and in particular less than 0.05% by weight.

The polyurethane of the invention here is preferably used in the interior of means of transport, for example ships, aircraft, trucks, cars, or buses, particularly preferably cars or buses, and in particular cars. The interior of these cars and buses is hereinafter termed automobile interior. Possible uses here are: a flexible polyurethane foam as seat cushioning, a semirigid polyurethane foam as backfoaming for door side elements or instrument panels, an integral polyurethane foam as steering wheel, control knob, or headrest, and a compact polyurethane by way of example as cable sheathing.

The polyisocyanate components (a) used for producing the polyurethanes of the invention comprise all of the polyisocyanates known for producing polyurethanes. These comprise the aliphatic, cycloaliphatic, and aromatic di- or polyfunctional isocyanates known from the prior art, and also any desired mixtures thereof. Examples are diphenylmethane 2,2′-, 2,4′- and 4,4′-diisocyanate, the mixtures of monomeric diphenylmethane diisocyanates and of diphenylmethane diisocyanate homologs having a larger number of rings (polymer MDI), isophorone diisocyanate (IPDI) and its oligomers, tolylene 2,4- or 2,6-diisocyanate (TDI), and mixtures of these, tetramethylene diisocyanate and its oligomers, hexamethylene diisocyanate (HDI) and its oligomers, and naphthylene diisocyanate (NDI) and mixtures thereof.

It is preferable to use tolylene 2,4- and/or 2,6-diisocyanate (TDI) or a mixture of these, monomeric diphenylmethane diisocyanates, and/or diphenylmethane diisocyanate homologs having a larger number of rings (polymer MDI), and mixtures of these. Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

The polyisocyanate component (a) can be used in the form of polyisocyanate prepolymers. These polyisocyanate prepolymers are obtainable by reacting polyisocyanates (constituent (a-1)) described above in excess, for example at temperatures of from 30 to 100° C., preferably at about 80° C., with polymeric compounds (b) having groups reactive toward isocyanates (constituent (a-2)) and/or chain extenders (c) (constituent (a-3)) to give the isocyanate prepolymer.

Polymeric compounds having groups reactive toward isocyanates (a-2) and chain extenders (a-3) are known to the person skilled in the art and are described by way of example in “Kunststoffhandbuch, Band 7, Polyurethane” [Plastics handbook, volume 7, Polyurethanes], Carl Hanser Verlag, 3rd edition, 1993, chapter 3.1. It is therefore possible by way of example that polymeric compounds (a-2) used having groups reactive toward isocyanates also comprise the polymeric compounds described under (b) below having groups reactive toward isocyanates.

Polymeric compounds (b) used having groups reactive toward isocyanates can comprise any of the known compounds having at least two hydrogen atoms reactive toward isocyanates, for example those with functionality of from 2 to 8 and with number-average molar mass of from 400 to 15 000 g/mol. It is therefore possible to use, by way of example, compounds selected from the group of polyether polyols, polyester polyols, and mixtures thereof.

Polyetherols are by way of example produced from epoxides, such as propylene oxide and/or ethylene oxide, or from tetrahydrofuran, with starter compounds comprising active hydrogen, for example aliphatic alcohols, phenols, amines, carboxylic acids, water, or compounds based on natural sources, for example sucrose, sorbitol, or mannitol, with use of a catalyst. Mention may be made here of basic catalysts or double-metal cyanide catalysts, for example as described in PCT/EP2005/010124, EP 90444 or WO 05/090440.

Polyesterols are by way of example produced from aliphatic or aromatic dicarboxylic acids and from polyhydric alcohols, polythioether polyols, polyesteramides, hydroxylated polyacetals and/or hydroxylated aliphatic polycarbonates, preferably in the presence of an esterification catalyst. Other possible polyols are given by way of example in “Kunststoffhandbuch, Band 7, Polyurethane” [Plastics handbook, volume 7, Polyurethanes], Carl Hanser Verlag, 3rd edition, 1993, Chapter 3.1.

Other materials that can be used alongside the polyetherols and polyesterols described are filled polyetherols or polyesterols, also termed polymer polyetherols or polymer polyesterols. Such compounds preferably comprise dispersed particles made of thermoplastics, for example composed of olefinic monomers, such as acrylonitrile, styrene, (meth)acrylates, (meth)acrylic acid, and/or acrylamide. Such filled polyols are known and obtainable commercially. Their production is described by way of example in DE 111 394, U.S. Pat. No. 3,304,273, U.S. Pat. No. 3,383,351, U.S. Pat. No. 3,523,093, DE 1 152 536, DE 1 152 537 WO 2008/055952, and WO2009/128279.

In one particularly preferred embodiment of the present invention, component (b) comprises polyetherols, and more preferably no polyesterols.

Catalysts (c) greatly accelerate the reaction of the polyols (b) and optionally chain extender and crosslinking agent (f), and also chemical blowing agent (e), with the organic, optionally modified polyisocyanates (a). The catalysts (c) here comprise incorporable amine catalysts. These have at least one, preferably from 1 to 8, and particularly preferably from 1 to 2, groups reactive toward isocyanates, examples being primary amine groups, secondary amine groups, hydroxy groups, amides, or urea groups, preferably primary amine groups, secondary amine groups, hydroxy groups. Incorporable amine catalysts are mostly used for producing low-emission polyurethanes, these being in particular used in the automobile interior sector. Such catalysts are known and are described by way of example in EP1888664. These materials comprise compounds which have one or more tertiary amino groups in addition to the group(s) reactive toward isocyanates. It is preferable that the tertiary amino groups of the incorporable catalysts bear at least two aliphatic hydrocarbon moieties, preferably having from 1 to 10 carbon atoms per moiety, particularly preferably having from 1 to 6 carbon atoms per moiety. It is particularly preferable that the tertiary amino groups bear two moieties selected mutually independently from methyl moiety and ethyl moiety, and also another organic moiety. Incorporable catalysts that can be used are by way of example bisdimethylaminopropylurea, bis(N,N-dimethylaminoethoxyethyl) carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethyaminopropyl-N,N-dimethylpropane-1,3-diamine, dimethyl-2-(2-aminoethoxyethanol), and (1,3-bis(dimethylamino)-propan-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl) ether, 3-dimethylaminoisopropyldiisopropanolamine, or a mixture thereof.

It is also possible to use conventional catalysts, alongside the incorporable amine catalysts, to produce the polyurethanes. Mention may be made by way of example of amidines, such as 2,3-dimethyl-3,4,5,6-tetrahydropyrimidine, tertiary amines, such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. It is also possible to use organometallic compounds, preferably organotin compounds, such as tin(II) salts of organic carboxylic acids, e.g. tin(II) acetate, tin(II) octoate, tin(II) ethylhexoate, and tin(II) laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, or a mixture thereof. The organometallic compounds can be used alone or preferably in combination with strongly basic amines. If component (b) involves an ester, it is preferable to use exclusively amine catalysts. In a particularly preferred embodiment, catalysts (c) used comprise exclusively incorporable catalysts.

If catalysts (c) are used, these can by way of example be used at a concentration of from 0.001 to 5% by weight, in particular from 0.05 to 2% by weight, in the form of catalyst or catalyst combination, based on the weight of component (b).

Component (d) used comprises one or more aliphatic hydrocarbons having from 2 to 15, preferably from 3 to 10, more preferably from 3 to 6, and in particular from 3 to 4, carbon atoms, and comprising at least one heteroatom selected from the group consisting of oxygen, nitrogen, and sulfur, and comprising at least one bromine and/or chlorine atom, preferably 2, 3, or 4 bromine and/or chlorine atoms, particularly preferably 2 or 3 bromine and/or chlorine atoms. In another preferred embodiment, the compound (d) comprises only one bromine or chlorine atom. The aliphatic hydrocarbon (d) preferably comprises chlorine as bromine and/or chlorine atom. The content of bromine and/or chlorine atoms here, particularly preferably of chlorine, is preferably at least 20% by weight, particularly preferably at least 30% by weight, and in particular at least 40% by weight, based in each case on the total weight of component (d). It is preferable that the aliphatic hydrocarbon (d) comprises at least one bromine and/or chlorine atom bonded to a primary carbon atom.

The aliphatic hydrocarbon (d) here can be linear, branched, or cyclic, preferably being linear or branched. The heteroatom here can be terminal or can be a bridging atom in the middle of the chain. Examples of heteroatoms in the middle of the chain are ether groups —O—, thioether groups —S—, and tertiary nitrogen groups. If at least one heteroatom is present in the middle of the chain, it is preferable that an ether group is involved. The aliphatic hydrocarbon (d) comprises, instead of the bridging atom, or in addition to the bridging atom, at least one group which has hydrogen atoms reactive toward isocyanate groups. Examples of such groups are —SH groups, —NH— groups, —NH₂ groups, and —OH groups. It is particularly preferable that the compound (d) has at least one OH group, in particular one secondary OH group. It is further preferable that the aliphatic hydrocarbon (d) has, in addition to the —OH group, a bridging atom, particularly preferably at least one ether group. In one particularly preferred embodiment, there are no more than 3 carbon atoms between the bromine and/or chlorine atom and the heteroatom, preferably no more than 2 carbon atoms. In particular, the compound (d) comprises an OH group, preferably a secondary OH group, on the carbon atom adjacent to the carbon atom bearing the bromine or chlorine atom. The aliphatic hydrocarbon (d) here comprises no phosphoric ester, polyphosphate, phosphonic ester, or phosphorous ester, and it is preferable that the aliphatic hydrocarbon (d) comprises no phosphorus atoms.

Aliphatic hydrocarbons (d) of the invention preferably have a boiling point under standard conditions of at least 100° C., particularly preferably at least 120° C., and in particular at least 150° C.

Examples of preferred aliphatic hydrocarbons (d) are 1,3-dichloro-2-propanol, 1,1,1-trichloro-2-methyl-2-propanol hemihydrates, 2-[2-(2-chloroethoxy)ethoxy]ethanol, 2-(2-chloroethoxy)ethanol, bis(2-(2-chloroethoxy)ethyl) ether, 1,2-dichloro-3-propanol, 3-chloro-1-propanol, 3-chloro-2,2,dimethyl-1-propanol, 1-chloro-2-propanol, 2-chloro-1-propanol, 3-bromo-1-propanol, 4-chloro-1-butanediol, 5-chloro-1-pentanol, and 6-chloro-1-hexanol. Particular preference is given to 1,3-dichloro-2-propanol, 1,2-dichloro-3-propanol, 1-chloro-2-propanol, and 3-chloropropanol, in particular 1,3-dichloro-2-propanol, 1-chloro-2-propanol, and 3-chloropropanol.

It is particularly preferably that the proportion of component (d), based on the total weight of components (a) to (g), is from more than 0 to less than 3% by weight, particularly preferably from 0.1 to 2.5% by weight, more preferably from 0.2 to 2% by weight, and in particular from 0.3 to 1.5% by weight. In one particularly preferred embodiment, the proportion of component (d), based on the total weight of components (a) to (g), is such that the entirety of the bromine and/or chlorine atoms comprised in (d) is from 0.1 to 1.0% by weight, particularly preferably from 0.15 to 0.8% by weight, and in particular from 0.2 to 0.6% by weight.

Polyurethanes of the invention are in essence produced without the use of mineral acids. Mineral acids are inorganic acids, such as phosphoric acid, hydrochloric acid, sulfuric acid, or nitric acid. “In essence without use of mineral acids” here means that small amounts which by way of example are comprised as a result of a production process have been excepted. The content of mineral acids is preferably smaller than 0.5% by weight, particularly preferably smaller than 0.1% by weight, more preferably smaller than 0.05% by weight, still more preferably smaller than 0.01% by weight, and in particular smaller than 0.001% by weight, based in each case on the total weight of the components (a) to (g). The content of phosphoric ester, polyphosphate, phosphonic ester, or phosphorous ester, based on the total weight of components (a) to (g), is moreover smaller than 0.5% by weight, particularly preferably smaller than 0.1% by weight, more preferably smaller than 0.05% by weight, still more preferably smaller than 0.01% by weight, and in particular smaller than 0.001% by weight.

If the polyurethane of the invention is intended to be a polyurethane foam, reaction mixtures of the invention also comprise blowing agents (e). It is possible here to use any of the blowing agents known for the production of polyurethanes. These can comprise chemical and/or physical blowing agents. Such blowing agents are described by way of example in “Kunststoffhandbuch, Band 7, Polyurethane” [Plastics handbook, volume 7, Polyurethanes], Carl Hanser Verlag, 3rd edition, 1993, chapter 3.4.5. The term chemical blowing agents here covers compounds which form gaseous products via reaction with isocyanate. Examples of such blowing agents are water and carboxylic acids. The term physical blowing agents here covers compounds which have been dissolved or emulsified in the starting materials for polyurethane production and which evaporate under the conditions of polyurethane formation. By way of example, these involve hydrocarbons, halogenated hydrocarbons, and other compounds, for example perfluorinated alkanes, such as perfluorohexane, fluorochlorocarbons, and ethers, esters, ketones, acetals, and/or liquid carbon dioxide. Any desired amount of the blowing agent can be used here. The amount used of the blowing agent is preferably such that the density of the resultant polyurethane foam is from 10 to 850 g/L, particularly from 20 to 800 g/L, and in particular from 25 to 500 g/L. It is particularly preferable to use blowing agents comprising water.

Chain extenders and crosslinking agents (f) that can be used comprise compounds which have at least two groups reactive toward isocyanates and which have a molar mass of less than 400 g/mol, where the term chain extenders is used for molecules which have two hydrogen atoms reactive toward isocyanate, and the term crosslinking agent is used for molecules which have more than two hydrogens reactive toward isocyanate. However, it is also possible to omit the chain extender or crosslinking agent here. However, the addition of chain extenders, crosslinking agents, or else optionally mixtures thereof, can prove advantageous for modifying mechanical properties, such as hardness.

If chain extenders and/or crosslinking agents (f) are used, use may be made of the chain extenders and/or crosslinking agents known in the production of polyurethanes. These are preferably low-molecular-weight compounds having functional groups reactive toward isocyanates, for example glycerol, trimethylolpropane, glycol, and diamines. Other possible low-molecular-weight chain extenders and/or crosslinking agents are given by way of example in

“Kunststoffhandbuch, Band 7, Polyurethane” [Plastics handbook, volume 7, Polyurethanes], Carl Hanser Verlag, 3rd edition, 1993, chapters 3.2 and 3.3.2.

Auxiliaries and/or additives (g) can moreover be used. It is possible here to use any of the auxiliaries and additives known for the production of polyurethanes. Mention may be made by way of example of surfactant substances, foam stabilizers, cell regulators, release agents, fillers, dyes, pigments, flame retardants, hydrolysis stabilizers, fungistatic substances, and bacteriostatic substances. Such substances are known and are described by way of example in “Kunststoffhandbuch, Band 7, Polyurethane” [Plastics handbook, volume 7, Polyurethanes], Carl Hanser Verlag, 3rd edition, 1993, chapters 3.4.4 and 3.4.6 to 3.4.11.

The general procedure in the production of the polyurethane of the invention is that the polyisocyanates (a), the polyols (b), the aliphatic hydrocarbon (d) having from 2 to 15 carbon atoms and comprising at least one heteroatom selected from the group consisting of oxygen, nitrogen, and sulfur, and comprising at least one bromine and/or chlorine atom, and optionally the blowing agents (e) and chain extenders and/or crosslinking agents (f) are reacted in amounts such that the equivalence ratio of NCO groups of the polyisocyanates (a) to the entirety of the reactive hydrogen atoms of components (b), (c), (d), and optionally (e) and (f) is from 0.75 to 1.5:1, preferably from 0.80 to 1.25:1. If the cellular plastics comprise isocyanurate groups at least to some extent, the ratio of NCO groups used in the polyisocyanates (a) to the entirety of the reactive hydrogen atoms of component (b), (c), (d), and optionally (e) and (f) is usually from 1.5 to 20:1, preferably from 1.5 to 8:1. A ratio of 1:1 here corresponds to an isocyanate index of 100.

The specific starting substances (a) to (g) for producing polyurethanes of the invention respectively differ only slightly in quantitative and qualitative terms when the intention is to produce, as polyurethane of the invention, a thermoplastic polyurethane, a flexible foam, a semirigid foam, a rigid foam, or an integral foam. By way of example, therefore, no blowing agents are used for the production of compact polyurethanes, and thermoplastic polyurethane uses mainly strictly difunctional starting substances. It is moreover possible by way of example to vary the elasticity and hardness of the polyurethane of the invention by way of the functionality and chain length of the relatively high-molecular-weight compound having at least two reactive hydrogen atoms. Such modifications are known to the person skilled in the art.

The starting materials for producing a compact polyurethane are described by way of example in EP 0989146 or EP 1460094, the starting materials for producing a flexible foam are described in PCT/EP2005/010124 and EP 1529792, the starting materials for producing a semirigid foam are described in “Kunststoffhandbuch, Band 7, Polyurethane” [Plastics handbook, volume 7, Polyurethanes], Carl Hanser Verlag, 3rd edition, 1993, chapter 5.4, the starting materials for producing a rigid foam are described in PCT/EP2005/010955, and the starting materials for producing an integral foam are described in EP 364854, U.S. Pat. No. 5,506,275, or EP 897402. The aliphatic hydrocarbon (d) having from 2 to 15 carbon atoms and comprising at least one heteroatom selected from the group consisting of oxygen, nitrogen, and sulfur, and comprising at least one bromine and/or chlorine atom, is then in each case added to the starting materials described in said documents.

The present invention further provides a process for producing polyurethanes of the invention by mixing (a) polyisocyanate, (b) polymeric compounds having groups reactive toward isocyanates, (c) optionally catalyst, (d) aliphatic hydrocarbon having from 2 to 15 carbon atoms which comprises at least one heteroatom selected from the group consisting of oxygen, nitrogen, and sulfur, and which comprises at least one bromine and/or chlorine atom, (e) optionally blowing agent, (f) optionally chain extender and or crosslinking agent, and (g) optionally auxiliary and/or additives to give a reaction mixture, and allowing the reaction mixture to complete its reaction to give the polyurethane, where the aliphatic hydrocarbon (d) comprises no phosphoric ester, polyphosphate, phosphonic ester, or phosphorous ester.

Polyurethanes of the invention exhibit excellent aging performance, in particular in heat-aging over 7 days at 140° C. or heat-aging at high moisture level over 3 cycles of 5 hours in an autoclave at 120° C. and 100% relative humidity. By using the aliphatic hydrocarbons (d) it was in particular possible to improve tensile strength, and also maximum tensile strain. The heat-aging and heat-aging at high moisture level here were carried out in accordance with DIN EN ISO 2440. Another advantage of the present invention is that the aliphatic hydrocarbons (d) have very good compatibility with polyols. Polyol components which comprise aliphatic hydrocarbons (d) of the invention therefore usually have very good stability in storage in the two-component process. Another advantage of polyurethanes of the invention is little discoloration during heat-aging.

Examples will be used below to illustrate the invention.
Starting Materials:
Polyol A: Polyetherol with OH number 35 mg KOH/g and functionality 2.7, based on ethylene oxide and propylene oxide, having 84% by weight propylene oxide content and 14% by weight ethylene oxide content
Polyol B: Graft polyol having 45% solids content (styrene-acrylonitrile) in polyol A as carrier polyol
Polyol C: Polyetherol with OH number 27 mg KOH/g and functionality 2.5, based on ethylene oxide and propylene oxide, having 78% by weight propylene oxide content and 21% by weight ethylene oxide content
BDO: 1,4-Butanediol
MEG: Monoethylene glycol
Isopur SA-21050: Black paste from ISL-Chemie
Polycat 15: Catalyst from Air Products
Jeffcat ZF10: Catalyst from Huntsman
Jeffcat DPA: Catalyst from Huntsman
DABCO: Triethylenediamine
Chlorinated Compounds
CI1: 1,3-Dichloro-2-propanol
CI2: 2-[2-(2-Chloroethoxy)ethoxy]ethanol
CI3: 2-(2-Chloroethoxy)ethanol
CI4: Bis(2-(2-chloroethoxy)ethyl) ether
CI5: TCPP
CI6: 3-Chloro-1-propanol
CI7: 3-Chloro-2,2-dimethyl-1-propanol
CI8: 1-Chloro-2-propanol
CI9: Cerechlor S45 (chlorinated C15-C17 paraffin, 45% CI from INEOS)
Br1: 3-Bromo-1-propanol
Isocyanate A: Carbodiimide-modified 4,4′-MDI having NCO content of 27.8

The mixture A was produced via mixing of the following components:

| | |
|---|---|
| 79.9 | parts by weight of (pts.) polyol A |
| 4.8 | parts by weight of polyol B |
| 8.1 | parts by weight of MEG |
| 5.0 | parts by weight of Isopur SA-21050 |
| 0.6 | part by weight of water |
| 0.8 | part by weight of Polycat 15 |
| 0.8 | part by weight of Jeffcat ZF10 |
| 0.25-2.0 | parts by weight of halogenated compounds Cl1 |
| | to Cl9 or Br1 in accordance with table 1 |

The mixture A and the isocyanate component A, and also the chlorinated compound in accordance with table 1, were mixed with one another at an isocyanate index of 102, and charged to a closed mold to give moldings with an average density of 380 g/L.

Isocyanate B: mixture of 85 parts of carbodiimide-modified 4,4′-MDI and 15 parts of polymeric diphenylmethane diisocyanate PMDI with an NCO content of 27.1

The mixture B was prepared via mixing of the following components:

| | |
|---|---|
| 85.3 | parts by weight of (pts.) polyol A |
| 10.0 | parts by weight of polyol C |
| 2.5 | parts by weight of water |
| 1.5 | parts by weight of triethanolamine |
| 0.2 | part by weight of Jeffcat DPA |
| 0.5 | part by weight of Jeffcat ZF10 |
| 0.5 | part by weight of Cl1 |

The mixture B and the isocyanate component B were mixed with one another at an isocyanate index of 104.5 and charged to a closed mold to give moldings with an average density of 137 g/L.
Isocyanate C: Mixture of 85 parts of modified 4,4′-MDI and 15 parts of polymeric diphenylmethane diisocyanate PMDI having an NCO content of 24.6

The mixture C was prepared via mixing of the following components:

| | |
|---|---|
| 86.6 | parts by weight of (pts.) polyol A |
| 11.0 | parts by weight of BDO |
| 0.1 | part by weight of water |
| 0.3 | part by weight of DABCO |
| 2.0 | parts by weight of Isopur SA-21050 |
| 0.4-1.0 | part by weight (pt.) of chlorinated compounds |
| | in accordance with table 3 |

The mixture C and the isocyanate component C, and also the chlorinated compound in accordance with table 4, were mixed with one another at an isocyanate index of 103 and charged to a closed mold to give moldings with an average density of 800 g/L.

The values measured for mechanical properties were determined by using procedures in accordance with the following standards.

| Property | Dimension | DIN standard |
|---|---|---|
| Hardness | Shore A | 53 505 |
| Tensile strength | kPa | 1798 |
| Tensile strain | % | 1798 |
| Density | g/mm³ | 845 |

The procedures for heat-aging and heat-aging with high moisture content were in accordance with the standard DIN EN ISO 2440.

TABLE 1
Table 1: Mechanical properties of the resultant integral foams before and after
heat-aging over 7 days at 140° C. without addition of chlorinated compounds
(ref.), and also with addition of the respective chlorinated compounds Cl1 to Cl9
and Br1 in the stated concentrations, in each case stated in parts by weight, based
on the total weight of the mixture A.

| Property | | | | Cl2 | | Cl3 | Cl4 | |
|---|---|---|---|---|---|---|---|---|
| Density: 380 g/L | | ref. | Cl1 0.4 pt | 0.9 pt | Cl2 1.8 pts | 1.0 pt | 0.6 pt | Cl4 2.4 pts |
| Tensile | 0 values | 2369 | 2173 | 2340 | 2171 | 2180 | 2240 | 2179 |
| strength, | Final | 1011 | 2005 | 1843 | 2177 | 1525 | 1426 | 1755 |
| kPa | values | | | | | | | |
| | Change | −57% | −8% | −21% | 0% | −30% | −36% | −19% |
| Tensile | 0 values | 106 | 103 | 113 | 114 | 110 | 103 | 110 |
| strain, % | Final | 17 | 123 | 106 | 131 | 67 | 63 | 101 |
| | values | | | | | | | |
| | Change | −84% | +19% | −6% | +15% | −39% | −39% | −8% |

| Property | | | Comp. Cl5 | Cl6 | Cl6 | Cl7 | Cl8 | Br10 | Br10 |
|---|---|---|---|---|---|---|---|---|---|
| Density: 380 g/L | | ref. | 0.5 pt | 0.5 pt | 1.0 pt | 1.2 pts | 1.0 pt | 1.0 pt | 2.0 pts |
| Tensile | 0 values | 2369 | 2266 | 2243 | 2215 | 2299 | 2444 | 2346 | 2036 |
| strength, | Final | 1011 | 1131 | 1657 | 2192 | 1890 | 2180 | 1745 | 2216 |
| kPa | values | | | | | | | | |
| | Change | −57% | −51% | −26% | −1% | −18% | −11% | −26% | +9% |
| Tensile | 0 values | 106 | 105 | 109 | 111 | 113 | 125 | 104 | 93 |
| strain, % | Final | 17 | 29 | 82 | 90 | 90 | 124 | 90 | 108 |
| | values | | | | | | | | |
| | Change | −84% | −73% | −25% | −19% | −20% | −1% | −14% | +16% |

TABLE 2
Table 2: Mechanical properties of the resultant semirigid
foams before and after heat-aging over 7 days at 140°
C. without addition of chlorinated compounds (ref.), and
also with addition of the chlorinated compound Cl1 at 0.5
part by weight, based on the total weight of the mixture B.

| | | |
|---|---|---|
| Property | | Cl1 |
| Density: 137 g/L | ref. | 0.5 pt |

| | | | |
|---|---|---|---|
| Tensile | 0 values | 426 | 417 |
| strength, | Final | 258 | 355 |
| kPa | values | | |
| | Change | −39% | −15% |
| Tensile | 0 values | 84 | 86 |
| strain, | Final | 50 | 63 |
| % | values | | |
| | Change | −41% | −27% |

TABLE 3
Table 3: Mechanical properties of the resultant integral foams before
and after heat-aging over 14 days at 150° C. without addition of
chlorinated compounds (ref.), and also with addition of the chlorinated
compound Cl1 and Cl3 in the stated concentrations, in each case stated
in parts by weight, based on the total weight of the mixture C.

| Property | | | Cl1 | Cl3 |
|---|---|---|---|---|
| Density: 800 g/L | | ref. | 0.4 pt | 1.0 pt |
| Tensile | 0 values | 4038 | 4136 | 4049 |
| strength, | Final | 1284 | 2226 | 1596 |
| kPa | values | | | |
| | Change | −71% | −46% | −60% |
| Tensile | 0 values | 87 | 115 | 102 |
| strain, | Final | 26 | 66 | 59 |
| % | values | | | |
| | Change | −70% | −43% | −42% |

TABLE 4
Table 4: Mechanical properties of the resultant integral foams
before and after heat-aging at high moisture level over 3 cycles
of 5 hours at 120° C. and 100% humidity in an autoclave
with addition of the respective chlorinated compounds Cl1 and
Cl4 in the concentrations stated, in each case stated in parts
by weight, based on the total weight of the mixture A.

| | | | Comp. | | | | | |
|---|---|---|---|---|---|---|---|---|
| Property | | | Cl9 | Cl1 | Cl2 | Cl4 | Cl6 | Cl8 |
| Density: 380 g/L | | ref. | 1.0 pt | 1.4 pts | 2.7 pts | 2.4 pts | 2.0 pts | 1.5 pts |
| Tensile | 0 values | 2326 | 2386 | 2285 | 2350 | 2333 | 2010 | 2211 |
| strength, | Final | 963 | 1127 | 1769 | 1225 | 1377 | 1688 | 1847 |
| kPa | values | | | | | | | |
| | Change | −59% | −53% | −23% | −48% | −41% | −16% | −17% |
| Tensile strain, % | 0 values | 110 | 116 | 109 | 110 | 108 | 116 | 115 |
| | Final | 70 | 87 | 128 | 69 | 92 | 93 | 137 |
| | values | | | | | | | |
| | Change | −36% | −25% | +17% | −37% | −15% | −20% | +19% |

1. A process for producing a polyurethane, the process comprising:
mixing
(a) polyisocyanate,
(b) polymeric compounds comprising groups reactive toward isocyanates,
(c) catalysts comprising incorporable amine catalysts,
(d) an aliphatic hydrocarbon comprising from 2 to 15 carbon atoms, at least one heteroatom selected from the group consisting of oxygen, nitrogen, and sulfur, and at least one of a bromine atom and a chlorine atom,
(e) optionally a blowing agent,
(f) optionally a chain extender, a crosslinking agent, or both, and
(g) optionally an auxiliary, additives, or both, thereby obtaining a reaction mixture, and
allowing the reaction mixture to react, thereby obtaining the polyurethane,
wherein the aliphatic hydrocarbon (d) comprises no phosphoric ester, polyphosphate, phosphonic ester, or phosphorous ester.

2. The process according to claim 1, wherein the aliphatic hydrocarbon (d) comprises a chlorine atom.

3. The process according to claim 1, wherein the aliphatic hydrocarbon (d) comprises groups reactive toward the polyisocyanates (a).

4. The process according to claim 1, wherein the aliphatic hydrocarbon (d) comprises no phosphorus atoms.

5. The process according to claim 1, wherein the aliphatic hydrocarbon (d) comprises at least 30% by weight of chlorine atoms, bromine atoms, or both.

6. The process according to claim 1, wherein a proportion of the aliphatic hydrocarbon (d), based on a total weight of components (a) to (g), is smaller than 3% by weight.

7. The process according to claim 1, wherein the polymeric compounds (b) comprise polyetherols.

8. The process according to claim 1, wherein the incorporable catalysts comprise compounds comprising a tertiary aliphatic amino group and a group reactive toward isocyanates.

9. The process according to claim 8, wherein the tertiary amino group comprises two moieties independently selected from the group consisting of a methyl moiety, an ethyl moiety and another organic moiety.

10. The process according to claim 1, wherein the polyurethane is a polyurethane foam with an average density of from 20 to 850 g/L.

11. The process according to claim 10, wherein the polyurethane foam is an integral polyurethane foam with an average density of from 150 to 500 g/L.

12. The process according to claim 10, wherein the polyurethane is a flexible polyurethane foam with an average density of from 20 to 100 g/L.

13. The process according to claim 1, wherein the polyurethane is a compact polyurethane with an average density of above 850 g/L.

14. The process according to claim 13, wherein the polyurethane is a cable sheathing.

15. A polyurethane produced by the process according to claim 1.

16. An interior of a conveyance, comprising the polyurethane according to claim 15.
